(19) United States
(12) Patent Application Publication
(10) Pub. No.: US 2004/0007090 A1
(43) Pub. Date: Jan. 15, 2004

(54) Securing device for securing an end of the toe strap on pedal

(76) Inventor: Chih-Ching Liou, Taichung City (TW)

Correspondence Address: CHARLES E. BAXLEY, ESQUIRE, Hart, Baxley, Daniels & Holton, 59 John St, 5 Fl,, New York, NY, 10038, US

(21) Appl. No.: 10/191,863

(22) Filed: Jul. 10, 2002

(51) Int. Cl. G05G 1/14

(52) U.S. Cl. 74/594.6

(57) ABSTRACT

A securing device of a pedal is connected to a surface of the body and includes a pawl which is pivotably connected to the body and has teeth defined therein. A first end of a toe strap is secured connected to a securing member connected to a side of the body and a tail or free end of the toe strap has teeth defined therein. The free or tail end of the toe strap is folded and engaged with the teeth of the pawl. By the securing device, the free or tail end of the toe strap is well positioned.

### FIELD OF THE INVENTION

The present invention relates to a securing device connected to a surface of the pedal so as to secure a tail end of the toe strap.

### BACKGROUND OF THE INVENTION

A conventional pedal assembly for a bicycle is disclosed in FIG. 1 and generally includes a pedal body 1, a first hook member 10 and a second hook member 100 respectively connected to two sides of the pedal body 1. A toe strap 15 has one end thereof securely connected to the second hook member 100 and the other end of the toe strap 15 has a plurality of apertures 150 defined therethrough. The toe strap 15 is pulled over the user's foot on the pedal body 1 and positions a user's foot on the pedal body 1 by engaging one of the apertures 150 with the first hook member 10. However, as illustrated in FIG. 1, a tail or free end of the toe strap 15 hangs over the pedal body 1 and is not well positioned. Therefore, this tail end of the toe strap 15 could hit the ground to generate noise or even be tangled by other objects. This may result in a dangerous accident.

The present invention intends to provide a securing device on the pedal so as to well secured the tail end of the toe strap.

### SUMMARY OF THE INVENTION

In accordance with one aspect of the present invention, there is provided a combination of a pedal and securing device, wherein the pedal body has a securing member on a first side of the body so as to be connected to a first end of a toe strap which has teeth defined in a surface thereof.

The securing device is connected to a surface of the body and includes a pawl which is pivotably connected to the body. The pawl has teeth defined therein which are engaged with the teeth of the toe strap.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional pedal assembly and the toe strap securing device;

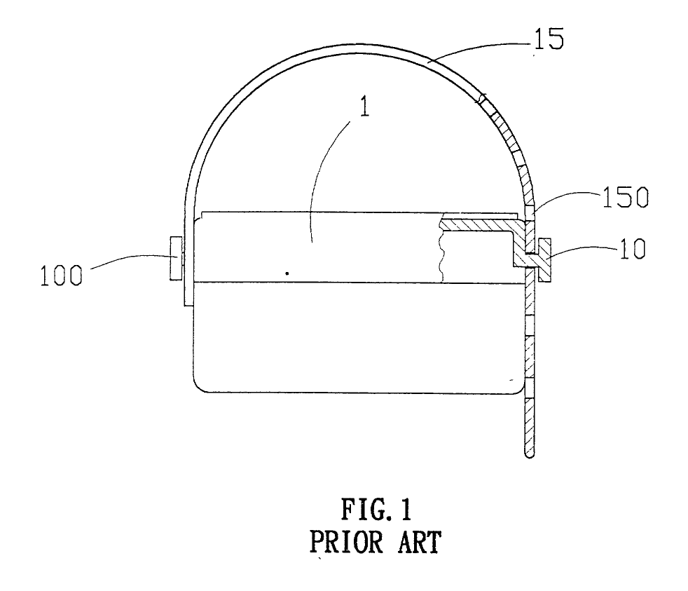

FIG. 2 is a perspective view to show the securing device of the present invention to secure the toe strap;

FIG. 3 is a cross sectional view to show the securing device of the present invention securing the toe strap;

FIG. 4 shows another embodiment of the pedal assembly of the present invention;

FIGS. 5 and 6 show another embodiment of the securing device of the present invention.

### DETAILED DESCRIPTION OF THE PREFERRED MBODIMENTS

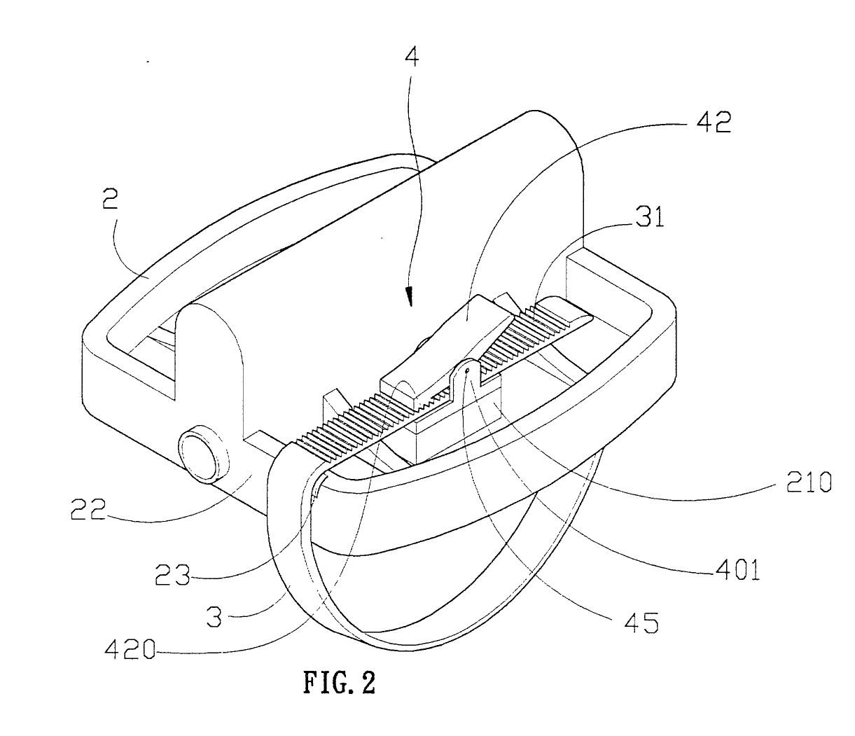

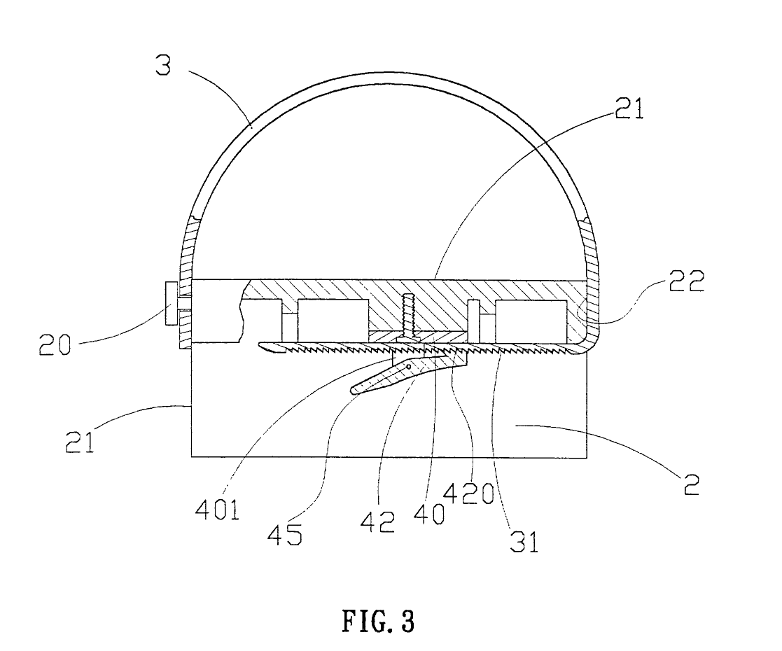

Referring to FIGS. 2 and 3, the pedal assembly and the securing device of the present invention comprises a pedal body 2 which is pivotably connected to a crank of a bicycle (both not shown). The body 2 has a securing member 20 on a first side 21 of the body 2 and a first end of a toe strap 3 is secured connected to the securing member 20. The toe strap 3 has teeth 31 defined in a surface close to a second end of the toe strap 3.

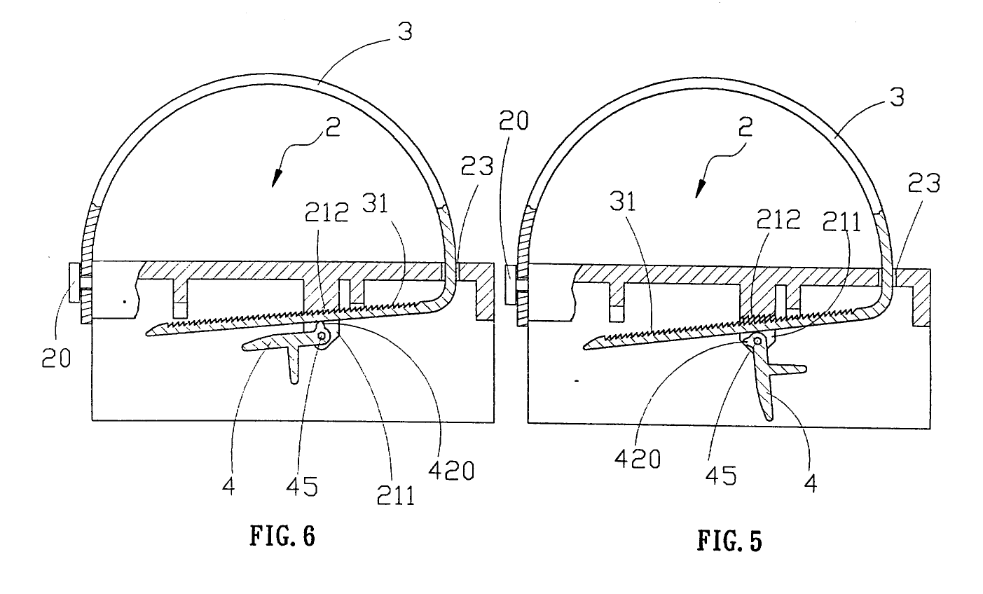

The securing device 4 is connected to a surface of the body 2 and includes a base 40 which is fixed to a block 210 on the surface of the body 2. The base 40 has two lugs 401 between which a pawl 42 is pivotably connected. A torsion spring 41 and a pin 45 as shown in FIG. 5 are used to connect the pawl 42 to the two lugs 401. The pawl 42 has teeth 420 defined therein which are engaged with the teeth 31 of the toe strap 3.

Is to be noted that the teeth 420 and the teeth 31 each have an inclined surface so that the user simply pushes the toe strap 3 to ward the pawl 42, the end having the teeth 420 is pushed upward when the teeth 31 move over the teeth 420 till the push force is stopped, the torsion spring 41 maintains the teeth 420 to be engaged with the teeth 31 all the time.

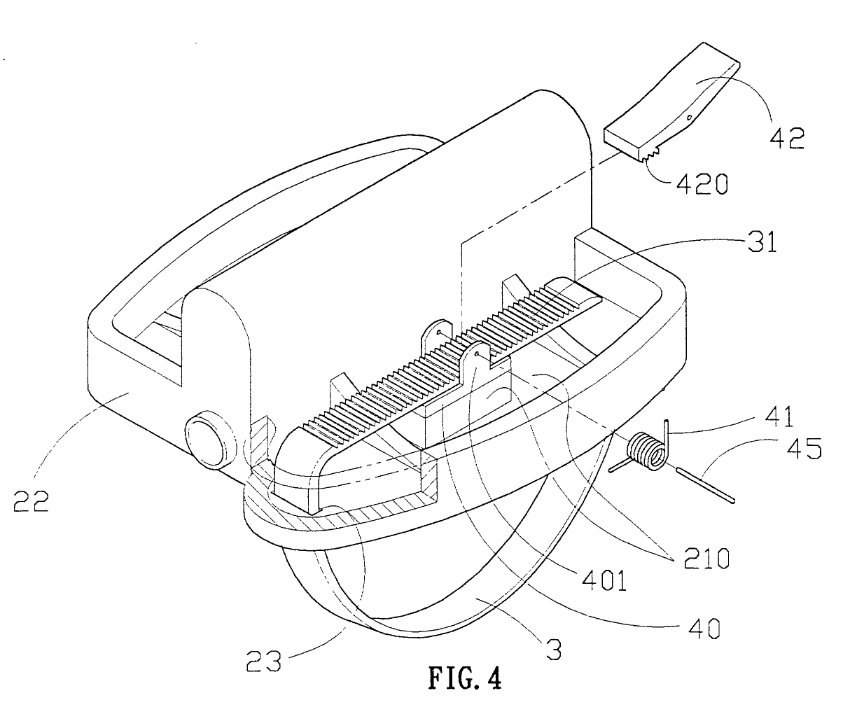

A notch 23 is defined in the second side 22 of the body 2 and the toe strap 3 is engaged with the notch 23. By this way, the toe strap 3 can be well positioned. Referring to FIG. 4, the notch 23 may be in a form of a hole 23 which is defined in the second side 22 of the body 2 and the toe strap 3 passes through the hole 23.

Referring to FIGS. 5 and 6, another embodiment of the securing device 4 includes a protrusion 211 which extends from the surface of the body 2 and a passage 212 is defined through the protrusion 211. A plurality of teeth are defined in an inner periphery of the passage 212 and the toe strap 3 passes through the passage 212 and the teeth of the passage 212 are engaged with the teeth 31 of the toe strap 3. The pawl 42 is pivotably connected to the protrusion 211 and presses the toe strap 3 toward the teeth in the passage 212 of the protrusion 211. A cam portion 420 is connected to an end of the pawl 4 and the toe strap 3 is pressed by the cam portion 420 when pivoting the pawl 4.

While we have shown and described the embodiment in accordance with the present invention, it should be clear to those skilled in the art that further embodiments may be made without departing from the scope of the present invention.

What is claimed is:

1. A combination of a pedal and a securing device, comprising:
a pedal body having a securing member on a first side of the body and a first end of a toe strap is secured connected to the securing member, the toe strap having teeth defined in a surface thereof, and
the securing device connected to a surface of the body and including a pawl which is pivotably connected to the body, the pawl having teeth defined therein which are engaged with the teeth of the toe strap.

2. The combination as claimed in claim 1, wherein securing device includes a base which is fixed to the surface of the body and has two lugs between which the pawl is pivotably connected.

3. The combination as claimed in claim 1, wherein the securing device includes a protrusion extending from the surface of the body and a passage defined through the protrusion, a plurality of teeth defined in an inner periphery of the passage and engaged with the teeth of the toe strap, the pawl pivotably connected to the protrusion and pressing the toe strap toward the teeth in the passage of the protrusion.

4. The combination as claimed in claim 3 further comprising a cam portion connected to an end of the pawl and the toe strap is pressed by the cam portion.

5. The combination as claimed in claim 1 further comprising a notch defined in a second side of the body and the toe strap engaged with the notch.

6. The combination as claimed in claim 1 further comprising a hole defined in a second side of the body and the toe strap passing through the hole.
